(19) United States
(12) Patent Application Publication
(10) Pub. No.: US 2007/0149166 A1
(43) Pub. Date: Jun. 28, 2007

(54) VOICE CALL CONTINUITY FOR EMERGENCY CALLS

(75) Inventors: Eric Turcotte, Verdun, QC (CA); Stephen Terrill, Madrid (ES)

Correspondence Address: ERICSSON CANADA INC.;PATENT DEPARTMENT, 8400 DECARIE BLVD., TOWN MOUNT ROYAL, QC, H4P 2N2, CA

(73) Assignee: TELEFONAKTIEBOLAGET LM ERICSSON (PUBL), Stockholm (SE)

(21) Appl. No.: 11/614,491

(22) Filed: Dec. 21, 2006

Related U.S. Application Data
(60) Provisional application No. 60/752,955, filed on Dec. 23, 2005.

(51) Int. Cl. H04M 11/04

(52) U.S. Cl. 455/404.1

(57) ABSTRACT

An enhanced Voice Call Continuity (VCC) application server and a method are described herein that: (1) assists in establishing an emergency call between a VCC capable User Equipment (UE) (which is located within an IMS network) and a Public Safety Access Point (PSAP); (2) assists in transitioning the emergency call from an IMS domain to a CS domain so the emergency call can be continued when the UE roams from the IMS network to a Circuit Switched (CS) network; and (3) assists the PSAP to call back the UE if the emergency call is dropped while the US is located in the CS network.

### CLAIMING BENEFIT OF PRIOR FILED U.S. APPLICATION

This application claims the benefit of U.S. Provisional Application Ser. No. 60/752,955 filed on Dec. 23, 2005 and entitled “Voice Call Continuity for Emergency Calls”. The contents of this document are hereby incorporated by reference herein.

### TECHNICAL FIELD

The present invention relates to a node (e.g., enhanced Voice Call Continuity Application Server (VCC AS)) and a method that supports voice call continuity for an emergency call between a User Equipment (UE) and a Public Safety Access Point (PSAP).

### BACKGROUND

The following abbreviations are herewith defined, at least some of which are referred to within the ensuing description of the prior art and the present invention.

| | |
|---|---|
| 3GPP | Third Generation Partnership Project |
| ACM | Address Complete Message |
| ANM | Answer Message |
| AS | Application Server |
| B2BUA | Back to Back User Agent |
| BGCF | Breakout Gateway Control Function |
| CAMEL | Customized Application for Mobile network |
| | Enhanced Logic |
| CCCF | Call Continuity Control Function |
| CSCF | Call Session Control Function |
| DNS | Domain Name System |
| E-CSCF | Emergency-CSCF |
| HLR | Home Location Register |
| IAM | Initial Address Message |
| IBCF | Interworking Border Control Function |
| I-CSCF | Interrogating CSCF |
| IMS | IP Multimedia Subsystem |
| ISC | IMS Service Control |
| IP | Internet Protocol |
| ISDN | Integrated Services Digital Network |
| ISUP | ISDN User Part |
| MGCF | Media Gateway Control Function |
| MGW | Media Gateway |
| MSISDN | Mobile Subscriber ISDN Number |
| MSRN | Mobile Station Routable Number |
| NeDS | Network Domain Selection |
| PC2.0 | Packet Cable 2.0 |
| P-CSCF | Proxy-CSCF |
| PRN | Provide Roaming Number |
| PSAP | Public Safety Answering Point |
| PSI | Public Service Identity |
| PSTN | Public Switched Telephone Network |
| S-CSCF | Serving CSCF |
| SIP | Session Initiation Protocol |
| SLF | Subscription Locator Function |
| SRI | Send Routing Information |
| UE | User Equipment |
| URI | Uniform Resource Identifier |
| VCC | Voice Call Continuity |

The current 3GPP Release 7 supports Voice Call Continuity which makes it possible to handover a call/session whenever a UE roams from an IMS network to a CS network, and vice versa. In addition, the current 3GPP Release 7 supports an emergency session where a UE while located within an IMS network is able to make an emergency call to a PSAP (e.g., 911 emergency call operator). These features are specified in the following documents (the contents of which are incorporated by reference herein):
3GPP TR 23.806: “Voice Call Continuity between CS and IMS Study (Release 7)”, V2.0.0 (December 2005).
3GPP TR23.867: “Internet Protocol (IP) based IP Multimedia Subsystem (IMS) Emergency Sessions”, V7.0.0 (September 2005).
3GPP TS.167: “IP Multimedia Subsystem (IMS) Emergency Sessions (Release 7)”, V0.2.0 (November 2005).

Unfortunately, in the current 3GPP approach, a VCC AS (e.g., CCCF NeDS) is not used or informed when a VCC capable UE (while located within an IMS network) makes an emergency call to the PSAP/emergency operator. This leads to several problems where: (1) if the UE roams from the IMS network (e.g., PC2.0, WiFi, WiMAX) to a CS network then the emergency call can not be handed-off so the emergency call will be dropped (note: an emergency call is not handled in the same manner as a regular call/session in the current 3GPP approach); and (2) if the emergency call is dropped because the UE roamed from the IMS network to the CS network then the PSAP/emergency operator will not be able to call back the UE. These problems and other problems are discussed in greater detail below with respect to the signaling flow diagrams shown in FIGS. 1A-1C.

Referring to FIG. 1A (PRIOR ART), there is illustrated a signal flow diagram which is used to help explain how a VCC capable UE establishes an emergency call with a PSAP (e.g., 911 emergency call operator) in accordance with the current 3GPP approach. In this scenario, the UE has wireless access to a visited IMS 100 network when it initiates an emergency call towards a PSAP. The steps for establishing the emergency call are as follows (note: the BGCF and I-CSCF have been omitted for simplicity):
1. The UE sends a SIP:INVITE (Emergency) to the P-CSCF.
2. The P-CSCF sends a SIP:INVITE (Emergency) to the E-CSCF.
3. The E-CSCF sends SIP:INVITE (Emergency) to the MGCF₁ (which is an interworking function that is used to convert packet switch signaling to circuit switch signaling and is needed if the PSAP is located in a CS network).
4. The MGCF₁ sends an ISUP:IAM (Calling#=MSISDN) to the PSAP (note: if the PSAP was a packet switched PSAP then the E-CSCF would have communicated directly with the PSAP and the MGCF₁ would not have been involved in the signaling).
5. The PSAP sends an ISUP:ANM to the MGCF₁.
6. The MGCF₁ sends a SIP:OK to the E-CSCF.
7. The E-CSCF sends a SIP:OK to the P-CSCF.
8. The P-CSCF sends a SIP:OK to the UE. At this point, a bearer path 102 for the emergency call is established between the UE and the PSAP via the MGW₁ (note: the MGW₁ would not have been used if the PSAP was a packet switched PSAP).

Referring to FIG. 1B (PRIOR ART), there is illustrated a signal flow diagram which is used to help explain why an ongoing emergency call is dropped when the UE roams from the IMS network 100 to the CS network 104. The steps which indicate the cause for this emergency call handoff problem are as follows (note: the BGCF and I-CSCF have been omitted for simplicity):
1. The UE sends a TS24.008:Setup (Called#: VCC AS PSI) to the VMSC (which is located in the CS network 104). In particular, the UE registers with the VMSC when it determines a need for a VCC transition to CS.
2. The VMSC sends a TS24.008:Call Proc to the UE.
3. The VMSC sends a ISUP:IAM to MGCF₂.
4. The MGCF₂ sends a SIP:INVITE (To: VCC AS PSI; Offer_{MGCF}) to the VCC AS (which is located in the home IMS network 106). In steps 3-4, the VMSC uses the VCC AS PSI to initiate a CS call to the VCC AS requesting it to perform a VCC transition of the active IMS call to the 3GPP CS domain. The CS call is routed via the MGCF₂ (and the I-CSCF/S-CSCF—not shown for clarity) to the VCC AS.
5. The VCC AS sends a SIP:403 Forbiden to the MGCF₂. Upon receiving the handover request, the VCC AS has no idea about the emergency call which was previously established in the IMS domain for that UE and as a result is not able to perform the requested handover of the emergency call. Thus, the VCC AS responds by sending the error message (e.g., SIP:403 Forbidden).
6. The MGCF₂ sends an ISUP:REL to the VMSC. Upon receiving 403 Forbidden from the VCC AS, the MGCF₂ sends the ISUP:REL towards the VMSC in order to reject the call.
7. The VMSC sends a TS24.008: Release to the UE. The handover of the emergency call can not be completed because the VCC AS was not aware that there was an ongoing emergency call in the IMS domain. Thus, the ongoing emergency call will be dropped. This is not desirable.

Referring to FIG. 1C (PRIOR ART), there is illustrated a signal flow diagram which is used to help explain why the PSAP can not call back the UE if the emergency call is dropped because the UE roamed from the IMS network to the CS network. The steps which indicate the cause for this PSAP call back problem are as follows (note: the BGCF and I-CSCF have been omitted for simplicity):
1. The PSAP sends an ISUP:IAM to the MGCF₂ (the PSAP attempts to call the UE back after the emergency call has been dropped).
2. The MGCF₂ sends a SIP:INVITE to the VCC AS (shown in this example as being located in the home IMS network 106). The VCC AS (also known as a CCCF/NeDS) supports the following functions: (1) CAMEL service; (2) CS adaptation function; (3) domain selection function; and (4) domain transfer function.
3. The VCC AS sends a SIP:INVITE to the S-CSCF (located in the home IMS network 106).
4. The S-CSCF sends a SIP:INVITE to the P-CSCF (which is located in the visited IMS network 100). In particular, the VCC AS sends the SIP:INVITE towards the last UE known location, i.e., the visited IMS network 100.
5. The P-CSCF sends a SIP:INVITE in an attempt to deliver the call back to the UE. However, the UE is no longer accessing the visited IMS network 100 since it has moved to the CS network 104.
6. The P-CSCF sends a SIP:Error Response Time Out to the S-CSCF.
7. The S-CSCF sends a SIP:Error Response Time Out to the VCC AS.
8. The VCC AS sends a SIP:Error Response Time Out to the MGCF₂.
9. The MGCF₂ sends an ISUP:REL to the PSAP. This signal indicates that the call can not be completed and has been released. This is not desirable.

As can be seen, there is a need to address the emergency call hand-off problem and the PSAP call back problem which are associated with the current 3GPP Release 7 standards. This need and other needs are satisfied by the present invention.

### SUMMARY

The present invention relates to a method and a node (enhanced VCC application server) which addresses the aforementioned problems by using a node which includes a processor and a memory with instructions stored therein which are accessible and processable by the processor to facilitate the following steps: (a) receiving a signal which indicates that a VCC capable User Equipment (UE) is attempting to place an emergency call while located in an Internet Protocol Multimedia Subsystem (IMS) network; and (2) initiating a call request towards an Emergency-Call Session Control Function (E-CSCF) located in the IMS network where the call request takes part in establishing the emergency call between the UE and a Public Safety Access Point (PSAP).

In another aspect, the present invention relates to a method and a node (enhanced VCC application server) which addresses the aforementioned problems by using a node which includes a processor and a memory with instructions stored therein which are accessible and processable by the processor to facilitate the following steps: (1) assisting in establishing an emergency call between a VCC capable UE and a PSAP (where the UE is located in an IMS network); (2) assisting in transferring the emergency call from an IMS domain to a CS domain so the emergency call can be continued when the UE roams from the IMS network to a CS network; and (3) assisting the PSAP to call back the UE if the emergency call is dropped while the UE is located in the CS network.

### BRIEF DESCRIPTION OF THE DRAWINGS

A more complete understanding of the present invention may be obtained by reference to the following detailed description when taken in conjunction with the accompanying drawings wherein:

FIGS. 1A-1C (PRIOR ART) are a set of signal flow diagrams which are used to help explain how an emergency call hand-off problem and a PSAP call back problem occur when utilizing the traditional 3GPP emergency services signaling;

FIGS. 2A-2C are a first set of signal flow diagrams which are used to help explain how an enhanced VCC AS can address both the emergency call hand-off problem and the PSAP call back problem in accordance with a first embodiment of the present invention;

FIGS. 3A-3C are a second set of signal flow diagrams which are used to help explain how an enhanced VCC AS can address both the emergency call hand-off problem and the PSAP call back problem in accordance with a second embodiment of the present invention; and

FIG. 4 is a flowchart which illustrates the steps of a method implemented by an enhanced VCC AS to address both the emergency call hand-off problem and the PSAP call back problem in accordance with the present invention.

### DETAILED DESCRIPTION

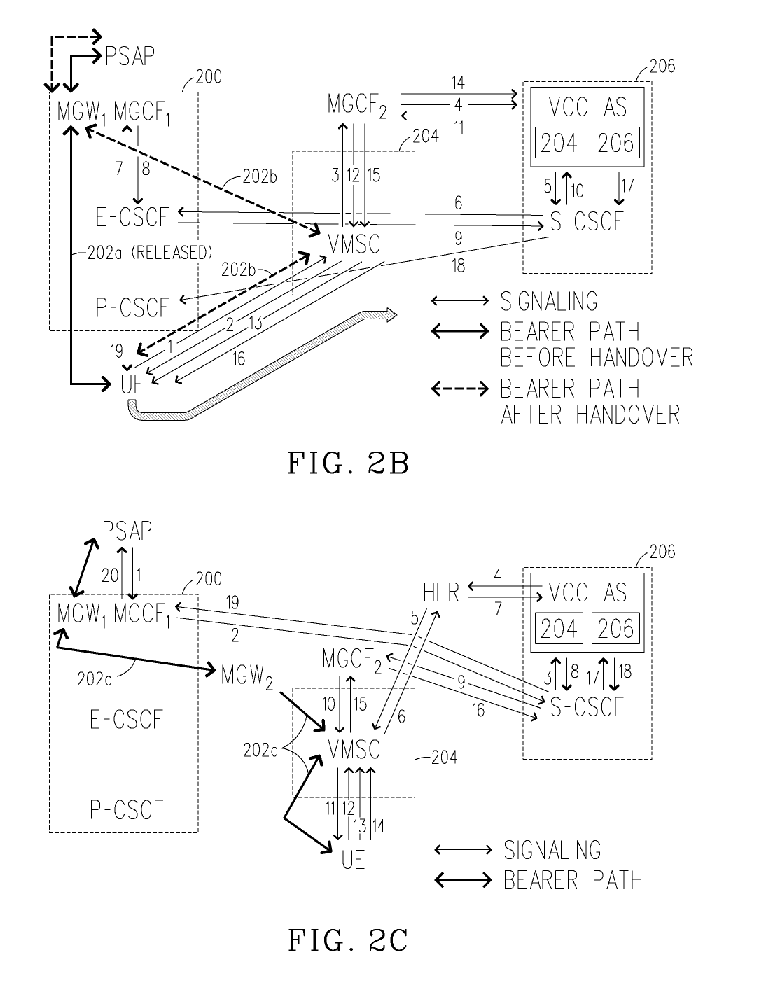

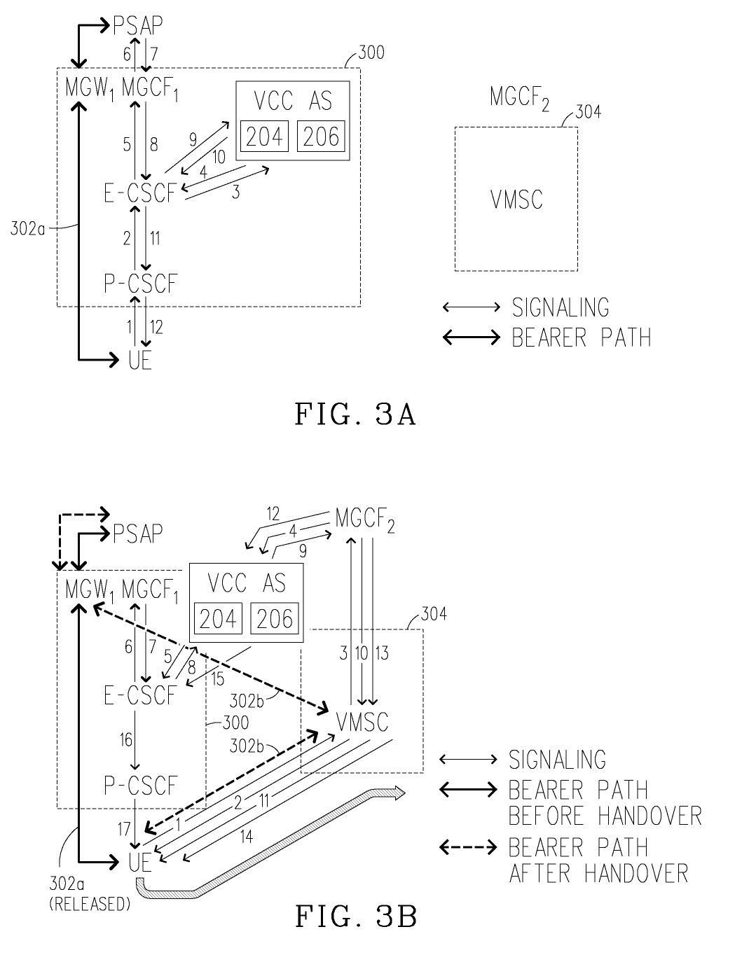

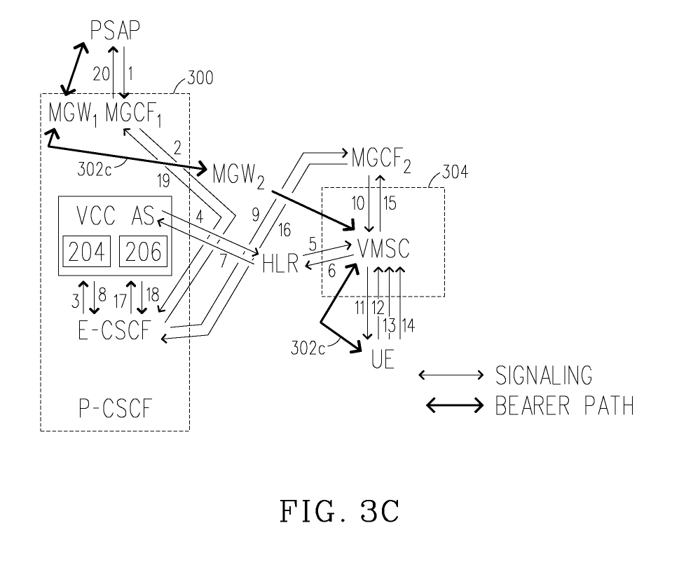

An enhanced VCC AS and a method 400 are described herein which addresses both of the emergency call hand-off problem and the PSAP call back problem by: (1) assisting in establishing an emergency call between a VCC capable UE and a PSAP (while the UE is located in an IMS network) (see FIGS. 2A and 3A); (2) assisting in transitioning the emergency call from an IMS domain to a CS domain so the ongoing emergency call can be continued after the UE roams from the IMS network to a CS network (see FIGS. 2B and 3B); and (3) assisting the PSAP to call back the UE if the emergency call is dropped while the US is located within the CS network (see FIGS. 2C and 3C). There are two different sets of signaling diagrams which are discussed below to help describe how the enhanced VCC AS addresses the aforementioned emergency call hand-off problem and the PSAP call back problem in accordance with the present invention (note: FIGS. 2A-2C is one set of signaling diagrams where the enhanced VCC AS is located within the home IMS network and FIGS. 3A-3C is the other set of signaling diagrams where the enhanced VCC AS is located within the visited IMS network).

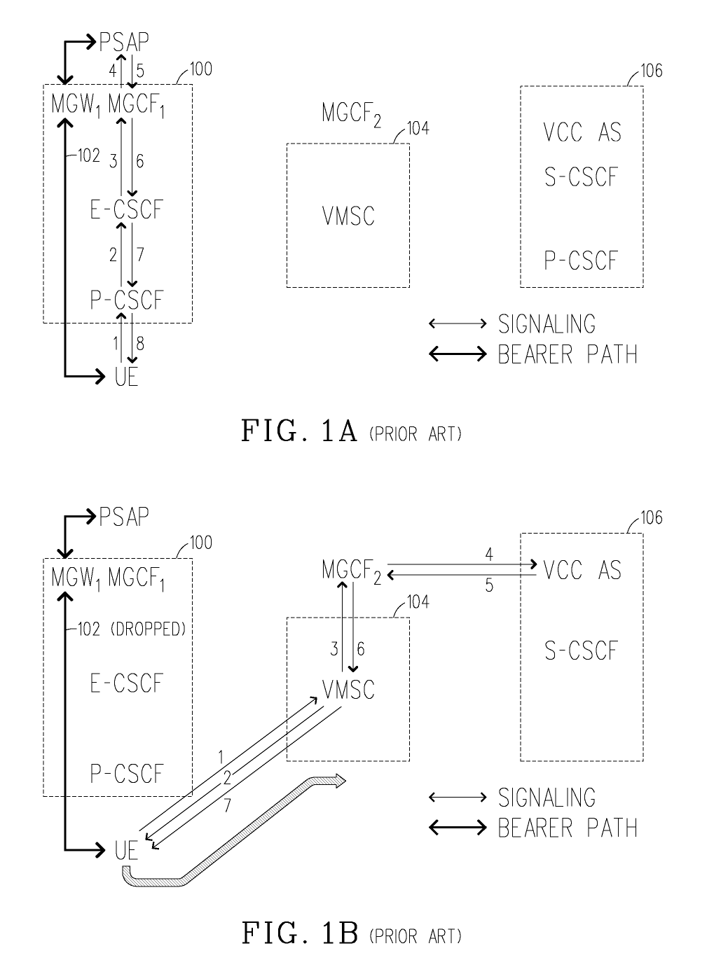

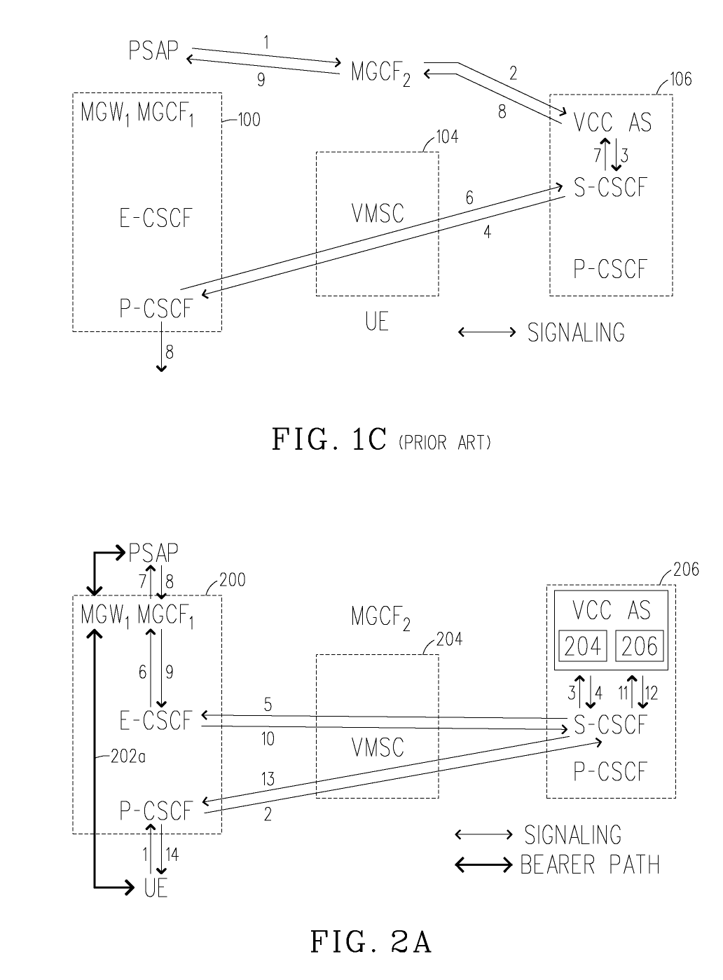

Referring to FIG. 2A, there is illustrated a signal flow diagram which is used to help describe how the enhanced VCC AS (which is located in the home IMS network 200) can assist in helping a VCC capable UE establish an emergency call with a PSAP in accordance with a first embodiment of the present invention. The steps for establishing the emergency call are as follows (note: the BGCF and I-CSCF have been omitted for simplicity)
1. The UE sends a SIP:INVITE (Emergency, VCC capable) to the P-CSCF (compare to step 1 shown in FIG. 1A).
2. The P-CSCF sends a SIP:INVITE (Emergency, VCC capable) to the S-CSCF (which is located in home IMS network 206). The P-CSCF forwards the INVITE after detecting that the call is an emergency call and learning that the UE is VCC capable.
3. The S-CSCF sends a SIP:INVITE via an ISC interface to the enhanced VCC AS (which is located in the home IMS network 206).
4. The enhanced VCC AS acting as a B2BUA sends a SIP:INVITE to the S-CSCF. In particular, the enhanced VCC AS which is acting as a third party call control sends an INVITE (e.g., 911@visitednetwork.com, sos@visitednetwork.com, emergency@visitednetwork.com) to the S-CSCF.
5. The S-CSCF sends a SIP:INVITE to the visited IMS network's I-CSCF (not shown) which in turn forwards the SIP:INVITE to the appropriate E-CSCF based on a DNS look-up. Alternatively, the visited IMS network/P-CSCF can include the specific E-CSCF URI in the emergency SIP:INVITE it sends to the home IMS network 206, so the enhanced VCC AS could then add the specific E-CSCF URI within the third party call control INVITE it sends to the visited IMS network 200. If this happens, then the I-CSCF does not need to perform a DNS lookup and the INVITE can be forwarded directly to the appropriate E-CSCF.
6. The E-CSCF sends a SIP:INVITE to the appropriate MGCF₁. The appropriate MGCF₁ may be selected based on the geographical location of the UE.
7. The MGCF₁ sends an ISUP:IAM (Calling #=MSISDN) to the PSAP.
8. The PSAP sends an ISUP:ANM to the MGCF₁.
9. The MGCF₁ sends a SIP:200 OK to the E-CSCF.
10. The E-CSCF sends a SIP:200 OK to the S-CSCF.
11. The S-CSCF sends a SIP:200 OK to the enhanced VCC AS.
12. The enhanced VCC AS sends a SIP:200 OK to the S-CSCF.
13. The S-CSCF sends a SIP:200 OK to the P-CSCF.
14. The P-CSCF sends a SIP:200 OK to the UE. At this point, a bearer path 202a (solid bold line) for the emergency call is established between the UE and the PSAP via the MGW₁ (note: the MGW₁ would not be used if the PSAP was a packet switched PSAP).

Referring to FIG. 2B, there is illustrated a signal flow diagram which is used to help describe how the enhanced VCC AS (which is located in the home IMS network 200) can assist in transitioning the emergency call from an IMS domain to a CS domain so the emergency call can be continued when the UE roams from the IMS network 200 to the CS network 204 in accordance with a first embodiment of the present invention. The steps for assisting in the handover of the emergency call when the UE roams into the CS network 204 are as follows (note: the BGCF and I-CSCF have been omitted for simplicity):
1. The UE sends a TS24.008:Setup (Called#: VCC AS PSI) to the VMSC (which is located in the CS network 204). In particular, the UE registers with the VMSC when it determines a need for a VCC transition to CS. Note: this CS call to the VMSC does not explicitly indicate that it is an emergency call so the enhanced VCC AS would not be bypassed. If the CS call had indicated that it was an emergency call, then the VMSC would establish a new emergency call with another PSAP (without the assistance of the enhanced VCC AS). This would not be desirable.
2. The VMSC sends a TS24.008:Call Proc to the UE.
3. The VMSC sends an ISUP:IAM to MGCF₂.
4. The MGCF₂ sends a SIP:INVITE (To: VCC AS PSI; Offer_{MGCF}) to the enhanced VCC AS. In steps 3-4, the VMSC initiates a CS call to the enhanced VCC AS using the VCC AS PSI requesting it to perform a VCC transition of the active IMS call to the 3GPP CS domain. The CS call is routed via the MGCF₂ (and the I-CSCF/S-CSCF—not shown for clarity) to the enhanced VCC AS.
5. The enhanced VCC AS sends a SIP:UPDATE (SDP_{MGCF}) to the S-CSCF. This step begins the process where the enhanced VCC AS transfers the UE's IMS leg to the CS domain.
6. The S-CSCF sends a SIP:UPDATE (SDP_{MGCF}) to the E-CSCF.
7. The E-CSCF sends a SIP:UPDATE (SDP_{MGCF}) to the MGCF₁.
8. The MGCF₁ sends a SIP:200 OK to the E-CSCF.
9. The E-CSCF sends a SIP:200 OK to the S-CSCF.
10. The S-CSCF sends a SIP:200 OK to the enhanced VCC AS.
11. The enhanced VCC AS sends a SIP:200 OK to the MGCF₂. In steps 5-11, the enhanced VCC AS performs the transfer of the user's IMS leg to the CS Domain by using SIP Session Transfer procedures. It is an implementation option as to how the SIP Session Transfer can be executed. The use of an UPDATE consisting of the SDP of the MGCF leg has been illustrated. However, other options such as a ReINVITE could be used instead to implement the Session Transfer.
12. The MGCF₂ sends an ISUP:ACM to the VMSC.
13. The VMSC sends a TS24.008:Altering to the UE.
14. The MGCF₂ sends a SIP:ACK to the enhanced VCC AS.
15. The MGCF₂ sends a ISUP:ANM to the VMSC.
16. The VMSC sends a TS24.008: Connect to the UE. In steps 12-16, the MGCF₂ upon receiving the SIP:200 OK sends the ISUP:ACM and ISUP:ANM to the VMSC. The MGCF₂ also acknowledges the SIP:200 OK by sending SIP:ACK back to the enhanced VCC AS. Plus, the VMSC sends the corresponding TS24.008: Altering and the TS24.008: Connect to the UE.
17. The enhanced VCC AS sends a SIP:BYE (IMS Call Ref) to the S-CSCF.
18. The S-CSCF sends a SIP:BYE (IMS Call Ref) to the P-CSCF.
19. The P-CSCF sends a SIP:BYE (IMS Call Ref) to the UE. In steps 17-19, the IMS bearer path 202a and the IMS signaling legs are released upon the successful execution of the SIP Session Transfer. At this point, a bearer path 202b (dashed bold line) for the emergency call has been established between the UE and the PSAP via the MGW₁ and the VMSC (note: the MGW₁ would not be used if the PSAP was a packet switched PSAP).

Referring to FIG. 2C, there is illustrated a signal flow diagram which is used to help describe how the enhanced VCC AS (which is located in the home IMS network 206) can assist the PSAP to call back the UE if the emergency call is dropped while the UE is located in the CS network 204 in accordance with a first embodiment of the present invention. The steps for assisting with the PSAP call back are as follows (note: the BGCF and I-CSCF have been omitted for simplicity):
1. The PSAP sends a ISUP:IAM (Called#: MSISDN, Calling#:PSAP#) to the MGCF₁. In particular, the PSAP attempts to call back the UE by sending an IAM message to the MSISDN that previously called. The MSISDN allows the call setup to be routed to the home IMS network 206 via the MGCF₁ using a normal IMS call delivery mechanism.
2. The MGCF₁ sends a SIP:INVITE (To: MSISDN, From: PSAP TelURI) to the S-CSCF. In particular, the MGCF₁ determines that the call should be routed to the home IMS network 206, via a SIP:INVITE message.
3. The S-CSCF sends a SIP:INVITE (To: MSISDN, From: PSAP TelURI) to the enhanced VCC AS. In particular, the S-CSCF checks the triggers for this UE and determines that the INVITE should be sent to the enhanced VCC AS.
4. The enhanced VCC AS sends a TS29.002:SRI (MSISDN) to a HLR.
5. The HLR sends a TS29.002:PRN (MSISDN) to the VMSC.
6. The VMSC sends a TS29.002:PRN Resp (MSRN) to the HLR.
7. The HLR sends a TS29.002:SRI Resp (MSRN) to the enhanced VCC AS. In steps 4-7, the enhanced VCC AS obtains a temporary routable number (MSRN) from the 3GPP CS cellular side.
8. The enhanced VCC AS sends a SIP:INVITE (MSRN) to the S-CSCF.
9. The S-CSCF sends a SIP:INVITE (MSRN) to the MGCF₂. In steps 8-9, the enhanced VCC AS delivers the call to the UE identified by the MSRN by sending an INVITE to the S-CSCF which is serving the MSISDN associated with the MRN. The S-CSCF delivers the INVITE to the MGCF₂ where the routing is based on the MSRN.
10. The MGCF₂ sends a ISUP:IAM (Called#:MSRN) to the VMSC. In particular, the MGCF₂ maps the INVITE to an ISUP IAM message which then gets routed to the VMSC.
11. The VMSC sends a TS24.008:Setup to the UE.
12. The UE sends a TS24.008:Call Confirmed to the VMSC.
13. The UE sends a TS24.008:Alerting to the VMSC.
14. The UE sends a TS24.008:Connect to the VMSC. In steps 11-14, the VMSC delivers the call to the UE using the standard TS 24.008 procedures and messages.
15. The VMSC sends a ISUP:ANM to the MGCF₂. In particular, the VMSC sends the ISUP:ANM to inform the MGCF₂ that the UE has answered the call.
16. The MGCF₂ sends a SIP:200 OK to the S-CSCF.
17. The S-CSCF sends a SIP:200 OK to the enhanced VCC AS. In steps 16-17, the MGCF₂ maps the ANM message in step 15 to a SIP 200 OK as per a standard mapping procedure and forwards the SIP:200 OK to the enhanced VCC AS.
18. The enhanced VCC AS sends a SIP:200 OK to the S-CSCF.
19. The S-CSCF sends a SIP:200 OK to the MGCF₁. In steps 18-19, the enhanced VCC AS forwards the SIP 200 OK towards the PSAP using normal IMS routing procedures. The enhanced VCC AS knows about the PSAP since it has kept the PSAP dialog context received during step 3.
20. The MGCF sends a ISUP:ANM to the PSAP. In particular, the MGCF, maps the SIP:200 OK to an ISUP ANM message to provide completion of the PSAP call back establishment. At this point, a bearer path 202c (solid bold line) for the emergency call has been established between the UE and the PSAP via two MGWs and the VMSC (note 1: the MGW, is shown located in the visited INS network but it could be located elsewhere) (note 2: for simplicity the signaling alerting back to the PSAP is not shown).

Referring to FIG. 3A, there is illustrated a signal flow diagram which is used to help describe how the enhanced VCC AS (which is located in the visited INS network 300) can assist in helping a VCC capable UE establish an emergency call with a PSAP in accordance with a second embodiment of the present invention. The steps for establishing the emergency call are as follows (note: the BGCF and I-CSCF have been omitted for simplicity)
1. The UE sends a SIP:INVITE (Emergency, VCC capable) to the P-CSCF (compare to step 1 shown in FIG. 1A).
2. The P-CSCF sends a SIP:INVITE (Emergency, VCC capable) to the E-CSCF.
3. The E-CSCF sends a SIP:INVITE (Emergency, VCC capable) to the enhanced VCC AS. The E-CSCF forwards the INVITE after detecting that the call is an emergency call and after learning that the UE is VCC capable. Alternatively, the P-CSCF detects that this is an emergency session and then sends a SIP:INVITE (Emergency, VCC capable) directly to the enhanced VCC AS.
4. The enhanced VCC AS acting as a B2BUA sends a SIP: INVITE to the E-CSCF. In particular, the enhanced VCC AS which is acting as a third party call control sends an INVITE (e.g., 911@visitednetwork.com, sos@visitednetwork.com, emergency@visitednetwork.com) to the E-CSCF.
5. The E-CSCF sends a SIP:INVITE to the appropriate MGCF₁. The appropriate MGCF₁ may be selected based on the geographical location of the UE.
6. The MGCF sends an ISUP:IAM (Calling #=MSISDN) to the PSAP.
7. The PSAP sends an ISUP:ANM to the MGCF₁.
8. The MGCF₁ sends a SIP:200 OK to the E-CSCF.
9. The E-CSCF sends a SIP:200 OK to the enhanced VCC AS.
10. The enhanced VCC AS sends a SIP:200 OK (with the enhanced VCC AS's address) to the E-CSCF. The enhanced VCC AS inserts it's address (e.g., VCC AS PSI) which is used later for calling the VMSC during a domain transfer to the CS network 304 (see FIG. 3B).
11. The E-CSCF sends a SIP:200 OK (with the enhanced VCC AS's address) to the P-CSCF.
12. The P-CSCF sends a SIP:200 OK (with the enhanced VCC AS's address) to the UE. At this point, a bearer path 302a (solid bold line) for the emergency call has been established between the UE and the PSAP via the MGW₁ (note: the MGW and MGCF₁ would not be used if the PSAP was a packet switched PSAP).

Referring to FIG. 3B, there is illustrated a signal flow diagram which is used to help describe how the enhanced VCC AS (which is located in the visited IMS network 300) can assist transitioning the emergency call from an IMS domain to a CS domain so the emergency call can be continued when the UE roams from the IMS network 300 to the CS network 304 in accordance with a second embodiment of the present invention. The steps for assisting in the handover of the emergency call when the UE roams into the CS network 304 are as follows (note: the BGCF and I-CSCF have been omitted for simplicity):
1. The UE sends a TS24.008:Setup (Called#: VCC AS PSI) to the VMSC (which is located in the CS network 304). In particular, the UE registers with the VMSC when it determines a need for a VCC transition to CS. Note: this CS call to the VMSC does not explicitly indicate that it is an emergency call so the enhanced VCC AS would not be bypassed. If the CS call had indicated that it was an emergency call, then the VMSC would establish a new emergency call with another PSAP (without the assistance of the enhanced VCC AS). This would not be desirable.
2. The VMSC sends a TS24.008:Call Proc to the UE.
3. The VMSC sends a ISUP:IAM to MGCF₂.
4. The MGCF₂ sends a SIP:INVITE (To: VCC AS PSI; Offer_{MGCF}) to the enhanced VCC AS. In steps 3-4, the VMSC uses the VCC AS PSI to initiate a CS call to the enhanced VCC AS requesting it to perform a VCC transition of the active IMS call to the 3GPP CS domain. The CS call is routed via the MGCF₂ (and the I-CSCF/S-CSCF—not shown for clarity) to the enhanced VCC AS.
5. The enhanced VCC AS sends a SIP:UPDATE (SDP_{MGCF}) to the E-CSCF. This step begins the process where the enhanced VCC AS transfers the UE's IMS leg to the CS domain.
6. The E-CSCF sends a SIP:UPDATE (SDP_{MGCF}) to the MGCF₁.
7. The MGCF₁ sends a SIP:200 OK to the E-CSCF.
8. The E-CSCF sends a SIP:200 OK to the enhanced VCC AS.
9. The enhanced VCC AS sends a SIP:200 OK to the MGCF₂. In steps 5-9, the enhanced VCC AS performs the transition of the user's IMS leg to the CS Domain by using SIP Session Transfer procedures. It is an implementation option as to how the SIP Session Transfer can be executed. The use of an UPDATE consisting of the SDP of the MGCF leg has been illustrated. However, other options such as a ReINVITE could be used instead to implement the Session Transfer.
10. The MGCF₂ sends an ISUP:ACM to the VMSC.
11. The VMSC sends a TS24.008:Altering to the UE.
12. The MGCF₂ sends a SIP:ACK to the enhanced VCC AS.
13. The MGCF₂ sends a ISUP:ANM to the VMSC.
14. The VMSC sends a TS24.008: Connect to the UE. In steps 10-14, the MGCF₂ upon receiving the SIP:200 OK sends the ISUP:ACM and ISUP:ANM to the VMSC. The MGCF₂ also acknowledges the SIP:200 OK by sending the SIP:ACK back to the enhanced VCC AS. Plus, the VMSC sends the corresponding TS24.008: Altering and the TS24.008: Connect to the UE.
15. The enhanced VCC AS sends a SIP:BYE (IMS Call Ref) to the E-CSCF.
16. The E-CSCF sends a SIP:BYE (IMS Call Ref) to the P-CSCF.
17. The P-CSCF sends a SIP:BYE (IMS Call Ref) to the UE. In steps 15-17, the IMS bearer path 302a and the IMS signaling legs are released upon the successful execution of the SIP Session Transfer. At this point, the bearer path 302b (dashed bold line) for the emergency call has been established between the UE and the PSAP via the MGW₁ and the VMSC (note: the MGW₁ and MGCF₁ would not be used if the PSAP was a packet switched PSAP).

Referring to FIG. 3C, there is illustrated a signal flow diagram which is used to help describe how the enhanced VCC AS (which is located in the visited IMS network) can assist the PSAP to call back the UE if the emergency call is dropped while the US is located in the CS network 304 in accordance with a second embodiment of the present invention. The steps for assisting with the PSAP call back are as follows (note: the BGCF and I-CSCF have been omitted for simplicity):
1. The PSAP sends a ISUP:IAM (Called#: “call back Nr, Calling #: PSAP#) to the MGCF₁. In particular, the PSAP attempts to call back the UE by sending an IAM message to the call back number Nr that was received during the hand-off procedure. The call back number Nr allows the call setup to be routed directly towards the visited IMS 300.
2. The MGCF₁ sends a SIP:INVITE (To: call back Nr, From: PSAP TelURI) to the E-CSCF. In particular, the MGCF₁ determines that the call should be routed to the specific E-CSCF (maybe via an I-CSCF) that owns the Call back number Nr.
3. The E-CSCF sends a SIP:INVITE (To: MSISDN, From: PSAP TelURI) to the enhanced VCC AS. The E-CSCF recalls that the UE was VCC capable and that the INVITE should be sent to the enhanced VCC AS.
4. The enhanced VCC AS sends a TS29.002:SRI (MSISDN) to a HLR.
5. The HLR sends a TS29.002:PRN (MSISDN) to the VMSC.
6. The VMSC sends a TS29.002:PRN Resp (MSRN) to the HLR.
7. The HLR sends a TS29.002:SRI Resp (MSRN) to the enhanced VCC AS. In steps 4-7, the enhanced VCC AS obtains a temporary routable number (MSRN) from the 3GPP CS cellular side. Alternatively, the enhanced VCC AS could forward the call to the MSISDN of the UE. To accomplish this, the enhanced VCC AS would have had to remember the MSISDN of the UE based upon the originally dialled emergency call. This call would go, via the E-CSCF, to a MGCF₂ then a normal terminating GSMN call would be initiated via a GMSC to the VMSC and then to the UE.
8. The enhanced VCC AS sends a SIP:INVITE (MSRN) to E-CSCF.
9. The E-CSCF sends a SIP:INVITE (MSRN) to the MGCF₂. In steps 8-9, the enhanced VCC AS delivers the call to the UE identified by the MSRN by sending an INVITE to the E-CSCF. The E-CSCF delivers the INVITE to the MGCF₂ using routing which is based on the MSRN.
10. The MGCF₂ sends a ISUP:IAM (Called#:MSRN) to the VMSC. In particular, the MGCF₂ maps the INVITE to an ISUP IAM message which gets routed to the VMSC.
11. The VMSC sends a TS24.008:Setup to the UE.
12. The UE sends a TS24.008:Call Confirmed to the VMSC.
13. The UE sends a TS24.008:Alerting to the VMSC.
14. The UE sends a TS24.008:Connect to the VMSC. In steps 11-14, the VMSC delivers the call to the UE using the standard TS 24.008 procedures and messages.
15. The VMSC sends a ISUP:ANM to the MGCF₂. In particular, the VMSC sends the ISUP:ANM to inform the MGCF₂ that the UE has answered the call.
16. The MGCF₂ sends a SIP:200 OK to the E-CSCF.
17. The E-CSCF sends a SIP:200 OK to the enhanced VCC AS. In steps 16-17, the MGCF₂ maps the ANM message in step 15 to a SIP 200 OK as per a standard mapping procedure and forwards the SIP:200 OK to the UE's E-CSCF and the enhanced VCC AS.
18. The enhanced VCC AS sends a SIP:200 OK to the E-CSCF.
19. The E-CSCF sends a SIP:200 OK to the MGCF₁. In steps 18-19, the enhanced VCC AS forwards the SIP 200 OK towards the PSAP using normal IMS routing procedures. The enhanced VCC AS knows about the PSAP since it has kept the PSAP dialog context received during step 3.
20. The MGCF sends a ISUP:ANM to the PSAP. In particular, the MGCF₁ maps the SIP:200 OK to an ISUP ANM message to provide completion of the PSAP call back establishment. At this point, a bearer path 302c (solid bold line) for the emergency call has been established between the UE and the PSAP via two MGWs and the VMSC (note 1: the MGW₁ is shown located in the visited IMS network 300 but it could be located elsewhere) (note 2: for simplicity the signaling alerting back to the PSAP is not shown) (note 3: if upon receiving a call back, the UE is reachable via the visited IMS 300 (i.e. is on a packet access) then the enhanced VCC AS forwards the call to the P-CSCF and then the UE. The address of the P-CSCF would have been remembered from when the original emergency call was made).

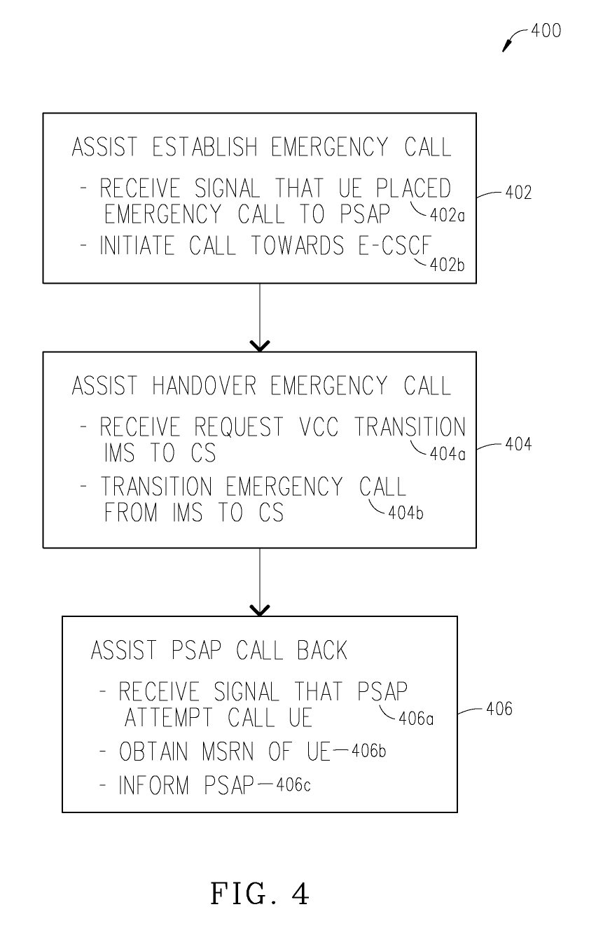

Referring to FIG. 4, there is a flowchart which illustrates the steps of a method 400 implemented by the enhanced VCC AS in accordance with the present invention. Basically, the enhanced VCC AS has a processor 204 which processes instructions stored within a memory 206 to perform the following steps: (1) assisting in establishing an emergency call between the VCC capable UE and the PSAP (while the UE is located in an IMS network) (see step 402 in FIG. 4); (2) assisting in transitioning the emergency call from the IMS domain to the CS domain so the emergency call can be continued when the UE roams from the IMS network to the CS network (see step 404 in FIG. 4); and (3) assisting the PSAP to call back the UE if the emergency call is dropped while the US is located in the CS network (see step 406 in FIG. 4).

At step 402, the enhanced VCC AS assists in establishing an emergency call between the UE and a PSAP (while the UE is located in an IMS network) by: (a) receiving a signal which indicates that the UE is attempting to place an emergency call while located in the IMS network (step 402a) (see also step 3 in FIG. 2A and step 3 in FIG. 3A); and (b) initiating a call towards the appropriate E-CSCF located in the IMS network to assist in establishing the emergency call between the UE and the PSAP (step 402b) (see also step 5 in FIG. 2A and step 4 in FIG. 3A).

At step 404, the enhanced VCC AS assists in transitioning the emergency call from the IMS domain to the CS domain so the emergency call can be continued when the UE roams from the IMS network to the CS network by: (a) receiving a signal from the CS network which is a request to perform a VCC transition of the emergency call from an IMS domain to a CS domain (step 404a) (see also step 4 in FIG. 2B and step 4 in FIG. 3B); and (b) transitioning the emergency call from the IMS domain to the CS domain so the emergency call is continued between the UE and the PSAP (step 404b) (see also steps 5, 11 and 17 in FIG. 2B and steps 5, 9 and 15 in FIG. 3B).

At step 406, the enhanced VCC AS assists the PSAP to call back the UE if the emergency call is dropped while the UE is located in the CS network by: (a) receiving a signal which indicates the PSAP is attempting to call back the UE (step 406a) (see also step 3 in FIG. 2C and step 3 in FIG. 3C); (b) obtaining a temporary routable number (MSRN) associated with the UE from the CS network (step 406b) (see also step 7 in FIG. 2C and step 7 in FIG. 3C); (c) using the temporary routable number (MRN) to deliver a call to the UE (step 406c) (see also step 8 in FIG. 2C and step 8 in FIG. 3C); and (d) upon learning that the UE answered the call, forwarding a message to the PSAP which then completes an emergency call back to the UE (step 406d) (see also step 17 in FIG. 2C and step 17 in FIG. 3C).

From the foregoing, it should be appreciated by those skilled in the art that the description provided herein did not discuss details about the IMS networks (e.g., PC2.0 networks) and the CS network and their associated components like the P-CSCF, MGCF, MGW, VMSC, S-CSCF, HLR etc . . . which are well known in the industry. Likewise, those skilled in the art will appreciate that description provided herein did not discuss in detail the functions and differences between SIP signals, ISUP signals, TS signals etc . . . since those details are well known in the industry.

Although two embodiments of the present invention have been illustrated in the accompanying Drawings and described in the foregoing Detailed Description, it should be understood that the invention is not limited to the disclosed embodiments, but instead is also capable of numerous rearrangements, modifications and substitutions without departing from the spirit of the invention as set forth and defined by the following claims.

1. A node, comprising:
a processor; and
a memory with instructions stored therein which are accessible and processable by said processor to facilitate the following steps:
receiving a signal which indicates that a VCC capable User Equipment (UE) is attempting to place an emergency call while located in an Internet Protocol Multimedia Subsystem (IMS) network; and
initiating a call request towards an Emergency-Call Session Control Function (E-CSCF) located in the IMS network where the call request takes part in establishing the emergency call between the UE and a Public Safety Access Point (PSAP).

2. The node of claim 1, wherein when the UE roams from the IMS network into a Circuit Switched (CS) network then said processor further facilitates the following steps:
receiving a signal from the CS network which indicates a request to perform a VCC transition of the emergency call from an IMS domain to a CS domain; and
transitioning the emergency call from the IMS domain to the CS domain so the emergency call is continued between the UE and the PSAP.

3. The node of claim 2, wherein when the emergency call is dropped while the UE is located in the CS network, then said processor further facilitates the following steps:
receiving a signal which indicates the PSAP is attempting to call back the UE;
obtaining a temporary routable number associated with the UE from the CS network;
using the temporary routable number to deliver a call to the UE; and
upon learning that the UE answered the call, forwarding a message to the PSAP which then completes the call back to the UE.

4. The node of claim 1, wherein the signal which indicates that the UE is attempting to place the emergency call is sent from the IMS network whenever the UE initiates the emergency call and also indicates that it is VCC capable.

5. The node of claim 1, wherein the signal which indicates that the UE is attempting to place the emergency call is sent from a P-CSCF in the IMS network whenever the UE initiates the emergency call and also indicates that it is VCC capable.

6. The node of claim 1, wherein the signal which indicates that the UE is attempting to place the emergency call is sent from the IMS network whenever the UE initiates the emergency call and the E-CSCF determines that the UE is VCC capable.

7. The node of claim 1, wherein the call request initiated towards the E-CSCF includes an emergency invite Uniform Resource Indicator (URI).

8. The node of claim 1, wherein the call request initiated towards the E-CSCF includes an emergency invite Uniform Resource Indicator (URI) along with a specific address of the E-CSCF.

9. The node of claim 1, wherein said node is an enhanced VCC application server located within a home IMS network.

10. The node of claim 1, wherein said node is an enhanced VCC application server located within a visited IMS network.

11. A method for establishing an emergency call between a VCC capable UE and a PSAP, said method comprising the steps of:
receiving a signal which indicates that a VCC capable User Equipment (UE) is attempting to place an emergency call while located in an Internet Protocol Multimedia Subsystem (IMS) network; and
initiating a call request towards an Emergency-Call Session Control Function (E-CSCF) located in the IMS network where the call request takes part in establishing the emergency call between the UE and a Public Safety Access Point (PSAP).

12. The method of claim 11, wherein when the UE roams from the IMS network into a Circuit Switched (CS) network then said method further includes the steps of:
receiving a signal from the CS network which indicates a request to perform a VCC transition of the emergency call from an IMS domain to a CS domain; and
transitioning the emergency call from the IMS domain to the CS domain so the emergency call is continued between the UE and the PSAP.

13. The method of claim 12, wherein when the emergency call is dropped while the UE is located in the CS network then said method further includes the steps of:
receiving a signal which indicates the PSAP is attempting to call back the UE;
obtaining a temporary routable number associated with the UE from the CS network;
using the temporary routable number to deliver a call to the UE; and
upon learning that the UE answered the call, forwarding a message to the PSAP which then completes the call back to the UE.

14. The method of claim 11, wherein the signal which indicates that the UE is attempting to place the emergency call is sent from the IMS network whenever the UE initiates the emergency call and also indicates that it is VCC capable.

15. The method of claim 11, wherein the signal which indicates that the UE is attempting to place the emergency call is sent from a P-CSCF in the IMS network whenever the UE initiates the emergency call and also indicates that it is VCC capable.

16. The method of claim 11, wherein the signal which indicates that the UE is attempting to place the emergency call is sent from the IMS network after the UE initiates the emergency call and the E-CSCF determines that the UE is VCC capable.

17. The method of claim 11, wherein the call request initiated towards the E-CSCF includes an emergency invite Uniform Resource Indicator (URI).

18. The method of claim 11, wherein the call request initiated towards the E-CSCF includes an emergency invite Uniform Resource Indicator (URI) along with an unique address of the E-CSCF.

19. A node, comprising:
a processor; and
a memory with instructions stored therein which are accessible and processable by said processor to facilitate the following steps:
assisting in establishing an emergency call between a VCC capable User Equipment (UE) and a Public Safety Access Point (PSAP) when the UE is located in an Internet Protocol Multimedia Subsystem (IMS) network;
assisting in transitioning the emergency call from an IMS domain to an Circuit Switched (CS) domain so that the emergency call is continued between the UE and the PSAP when the UE roams from the IMS network to a CS network; and
assisting in helping the PSAP to call back the UE if the emergency call is dropped when the US is located within the CS network.

20. The node of claim 19, wherein said processor assists in establishing the emergency call between the UE and the PSAP when the UE is located in the IMS network by facilitating the following steps:
receiving a signal which indicates that the UE is attempting to place the emergency call while located in the IMS network; and
initiating a call request towards an Emergency-Call Session Control Function (E-CSCF) located in the IMS network where the call request takes part in establishing the emergency call between the UE and the PSAP.

21. The node of claim 19, wherein said processor assists in transferring the emergency call from an IMS domain to a CS domain such that the emergency call is continued between the UE and the PSAP when the UE roams from the IMS network to a CS network by facilitating the following steps:
receiving a signal from the CS network which indicates a request to perform a VCC transition of the emergency call from the IMS domain to the CS domain; and
transitioning the emergency call from the IMS domain to the CS domain so the emergency call is continued between the UE and the PSAP.

22. The node of claim 19, wherein said processor assists in helping the PSAP call back the UE if the emergency call is dropped when the US is located within the CS network by facilitating the following steps:
receiving a signal which indicates the PSAP is attempting to call back the UE;
obtaining a temporary routable number associated with the UE from the CS network;
using the temporary routable number to deliver a call to the UE; and
upon learning that the UE answered the call, forwarding a message to the PSAP which then completes the call back to the UE.
